(19) United States
(12) Patent Application Publication
(10) Pub. No.: US 2020/0037627 A1
(43) Pub. Date: Feb. 6, 2020

(54) DRY SOLID YOGURT, CEREAL FOOD CONTAINING THE SAME, AND METHOD FOR PRODUCING DRY SOLID YOGURT

(71) Applicant: NAGATANIEN HOLDINGS CO., LTD., Tokyo (JP)

(72) Inventor: Michimasa Kumagai, Tokyo (JP)

(21) Appl. No.: 16/514,694

(22) Filed: Jul. 17, 2019

(30) Foreign Application Priority Data
Aug. 1, 2018 (JP) 2018-145242

(51) Int. Cl. A23C 9/154; A23C 9/13

(52) U.S. Cl. CPC A23C 9/1546; A23C 9/1307

(57) ABSTRACT

According to the embodiment of the present invention, there is provided a dry solid yogurt. The dry solid yogurt includes a vacuum freeze-dried product containing yogurt, non-fat powdered milk and dextrin.

### CROSS-REFERENCE TO RELATED APPLICATIONS

This application is based upon and claims the benefit of priority from Japanese Patent Application No. 2018-145242, filed Aug. 1, 2018, the entire contents of which are incorporated herein by reference.

### FIELD

The present invention relates to dry solid yogurt, cereal food containing the same, and a method for producing dry solid yogurt.

### BACKGROUND

Yogurt is made from cow's milk, or the like, through lactic fermentation. Due to its microbial cell body and functional ingredients, consumers have a highly healthy image of yogurt. In accordance with an increase of health consciousness or diversification of consumer preference and tastes, there is an increasing demand for products containing yogurt in combination with another dry food. Yogurt is normally of a liquid or pasty texture; however, yogurt needs to be dry when combined with other dry food.

Conventionally, freeze-drying is known as a suitable method to dry yogurt. For example, Jpn. Pat. Appln. KOKOKU Publication No. 60-54009 discloses a method for producing dry granular yogurt, though yogurt is not combined with another food in this method. In the method, yogurt with the addition of non-fat powdered milk is used. First, yogurt with non-fat powdered milk is dewatered into paste by freeze-drying. Next, pasty yogurt is rapidly frozen, thereafter shaped into granules, and then frozen and dried (refer to claim 1 etc. of Jpn. Pat. Appln. KOKOKU Publication No. 60-54009).

However, the dry granular yogurt obtained by the method disclosed in Jpn. Pat. Appln. KOKOKU Publication No. 60-54009 is intended to be used as a liquid or paste again after it is dissolved in water or the like, so that consumers can consume it as normal yogurt. As described above, the granular dry yogurt of the conventional art is not used in combination with other food. An object of the conventional art is to improve the dissolvability of dry yogurt in water and to improve the retention of activated lactic bacteria (refer to Jpn. Pat. Appln. KOKOKU Publication No. 60-54009, column 2, lines 4 to 9).

In the method disclosed in Jpn. Pat. Appln. KOKOKU Publication No. 60-54009, to quickly dissolve the dry granular yogurt in cold water, freeze drying is not completely performed. More specifically, the method is characterized by the pasty yogurt containing water at a ratio of 30 to 45 mass % being initially produced as an intermediate, and then dry granular yogurt with a large-surface area structure being obtained. If the water content ratio of the pasty yogurt as the intermediate exceeds 45 mass %, the resultant dry granules are in a fragile state due to having large surface areas, and easily broken into fine powders even with a small shock. Thus, the resultant dry granular yogurt is difficult to handle (Jpn. Pat. Appln. KOKOKU Publication No. 60-54009, column 3, lines 19 to 35).

### SUMMARY

When dry solid yogurt is used in a mixture with another product, the dry solid yogurt is required to have a performance specific to the product that needs to be mixed. For example, in recent years, cereal products with dry solid yogurt have been developed as products particularly appealing to health-conscious consumers. When developing dry solid yogurt for use in the cereal products, since the dry solid yogurt is mixed with cereal, transported as a commercial product, and generally eaten together with milk, the dry solid yogurt is required to exhibit superior performance in the following three respects:

The first is a shape retention (strength) that can withstand a shock during mixture with cereal or transportation. The second is a water resistance to maintain a floating state as a solid on an aqueous medium, such as milk; that is, even when the dry solid yogurt is brought into contact with the aqueous medium, it does not dissolve completely for a while, so that the presence of the dry solid yogurt can be appealed to the consumers. The third is a performance that maintains a crispy texture for a while even when the dry solid yogurt is brought into contact with an aqueous medium, such as milk.

However, if yogurt of a high water content ratio is frozen and dried without any processing, the resultant dry yogurt in the shape of blocks (solids) will be fragile. Furthermore, when yogurt with a high water content ratio is brought into contact with a liquid medium, it will be immediately dissolved or softened, and the presence will be less appealing.

It is possible to increase the density of the solid by adding non-fat powdered milk, gelatin, dietary fiber, gelatinizing agent, etc. to yogurt, thereby enhancing the presence of dry yogurt to a certain extent. However, the inventor of the present application has confirmed that the conventional dry yogurt does not achieve the three performances described above. Furthermore, there is the problem of addition of the aforementioned materials involving a high cost depending on the kind of additives, or impairing the flavor of the yogurt. Moreover, it is desirable not to use allergens, such as gelatin, as far as possible.

As described above, dry solid yogurt that is excellent in all of shape retention, water resistance, crispy texture, and flavor has not been developed. Under these circumstances, it is desirable to develop dry solid yogurt suitable for use in combination with dry food, such as cereal.

The present invention has been developed in consideration of the situation described above. An object of the present invention is to provide, at a low cost, dry solid yogurt that is excellent in shape retention, water resistance, crispy texture, and flavor, and to provide cereal food containing the dry solid yogurt. Another object of the present invention is to provide a method for producing dry solid yogurt that is excellent in shape retention, water resistance, crispy texture, and flavor at a low cost in a simple way.

The present invention has, for example, the following aspects.

<Aspect 1>

A dry solid yogurt including a vacuum freeze-dried product containing yogurt, non-fat powdered milk, and dextrin.

<Aspect 2>

The dry solid yogurt according to aspect 1, wherein a compounding ratio of the yogurt, the non-fat powdered milk, and the dextrin, as a material to be subjected to vacuum freeze-dry, satisfies formula (I):

20%≤a+b≤40% and 0%<b<20% (I)

In formula (I), a denotes a mass percentage (%) of non-fat powdered milk relative to yogurt, and b denotes a mass percentage (%) of dextrin relative to yogurt.

In the above formula (I), the condition of a+b may be 25%≤a+b≤35%. The condition of b may be 5%<b<15%.

<Aspect 3>

The dry solid yogurt according to aspect 1 or 2, wherein a dextrose equivalent (DE) of the dextrin is 5 to 12. The DE of the dextrin may be 6 to 10.

<Aspect 4>

The dry solid yogurt according to any one of aspects 1 to 3, wherein the yogurt is raw milk yogurt.

<Aspect 5>

The dry solid yogurt according to any one of aspects 1 to 4, wherein no gelatin is contained.

<Aspect 6>

Cereal food containing the dry solid yogurt according to any one of aspects 1 to 5.

<Aspect 7>

A method for producing a dry solid yogurt including: mixing yogurt, non-fat powdered milk, and dextrin; freezing a mixture obtained by the mixing; and vacuum freeze-drying a frozen product obtained by the freezing.

<Aspect 8>

The method for producing a dry solid yogurt according to aspect 7, wherein a compounding ratio of the yogurt, the non-fat powdered milk, and the dextrin, to be used in the mixing satisfies formula (I):

20%≤a+b≤40% and 0%<b<20% (I)

In formula (I), a denotes a mass percentage (%) of non-fat powdered milk relative to yogurt, and b denotes a mass percentage (%) of dextrin relative to yogurt.

In the above formula (I), the condition of a+b may be 25%≤a+b≤35%. The condition of b may be 5%<b<15%.

<Aspect 9>

The method for producing a dry solid yogurt according to aspect 7 or 8, wherein the mixture obtained by the mixing has a water content ratio of 60 to 70 mass %.

The mixture obtained by the mixing may have a water content ratio of 62 to 68 mass %.

<Aspect 10>

The method for producing a dry solid yogurt according to any one of aspects 7 to 9, wherein a dextrose equivalent (DE) of the dextrin is 5 to 12. The DE of the dextrin may be 6 to 10.

<Aspect 11>

The dry solid yogurt according to any one of aspects 7 to 10, wherein the yogurt is raw milk yogurt.

<Aspect 12>

The dry solid yogurt according to any one of aspects 7 to 11, wherein the dry solid yogurt contains no gelatin.

According to the present invention, it is possible to provide, at a low cost, dry solid yogurt that is excellent in shape retention, water resistance, crispy texture, and flavor, and also cereal food containing the dry solid yogurt. According to the present invention, it is also possible to provide a method for producing dry solid yogurt that is excellent in shape retention, water resistance, crispy texture, and flavor at a low cost in a simple way.

### BRIEF DESCRIPTION OF DRAWINGS

FIG. 1 is a scatter plot graph showing an example of influences of the compounding ratio of non-fat powdered milk and dextrin relative to yogurt on the performances of dry solid yogurt.

FIG. 2 is a graph showing an example of influences of the compounding ratio between non-fat powdered milk and dextrin on shape retention (degree of abrasion resistance).

### DETAILED DESCRIPTION

Embodiments of the present invention will be described below.

The dry solid yogurt of the embodiments of the present invention is excellent in shape retention, water resistance, crispy texture, and flavor. In this specification, the term “shape retention” means a sufficient strength to maintain the block shape against friction with another food, such as cereal, to be mixed with yogurt, and a shock which may occur during transport. The term “water resistance” means a performance that can maintain, when in contact with an aqueous medium such as milk, a state of floating on the aqueous medium, suppressing absorption of the aqueous medium for a while. On the assumption that the dry solid yogurt of the present invention finally dissolves, the term “water resistance” does not mean the performance resulting in the dry solid yogurt permanently remaining, without dissolving in, for example, the aqueous medium. The term “excellent in crispy texture” means not only that the dry solid yogurt itself has a crispy texture but also that the crispy texture can be maintained even after being brought into contact with the aqueous medium, such as milk.

A dry solid yogurt according to the embodiment of the present invention includes a vacuum freeze-dried product containing yogurt, non-fat powdered milk, and dextrin. In other words, the dry solid yogurt according to the embodiment of the present invention is a dry solid yogurt obtained by vacuum freeze-drying yogurt that contains yogurt, non-fat powdered milk, and dextrin.

In the present invention, “yogurt” may be any food that can be obtained by fermenting a material containing milk and lactic bacteria, not only plain yogurt consisting of milk and lactic bacteria; it may include fruit juice, flesh of fruit, gummy matter, polysaccharide thickener, or sweetening. It may either be hard yogurt or soft yogurt. However, in one embodiment of the present invention, yogurt preferably does not contain allergens, such as gelatin.

Generally, yogurt has a high water content ratio, for example 85 mass % or more, according to the food composition table. The dry solid yogurt obtained simply by vacuum freeze-drying yogurt having a high water content ratio has a high void ratio and a fragile property. Therefore, it cannot withstand a shock, or the like, and may be easily broken.

Since the density of the solid in the vacuum freeze-dried product can be increased by adding non-fat powdered milk to yogurt, the strength can be increased to a certain extent by increasing the additive amount. However, according to diligent studies by the present inventor, it was discovered that if the additive amount of non-fat powdered milk is increased to obtain a desired shape retention, namely a sufficient strength to maintain the block shape against friction with another food to be mixed with yogurt and a shock which may occur during transport, the additive amount will be too large. In this case, the water resistance and the texture will deteriorate, and the flavor of yogurt will be impaired.

In the embodiment of the present invention, dextrin is used in addition to non-fat powdered milk as an additive to yogurt. By using both non-fat powdered milk and dextrin as additives, the shape retention (strength) can be improved to a desired level with a lower amount of additives as compared to the case of using only non-fat powdered milk. Furthermore, the water resistance and texture can also be improved. Thus, even when the dry solid yogurt of this embodiment is brought into contact with an aqueous medium, such as milk, it can suppress absorption of the aqueous medium, can be kept floating on the medium, and can maintain the crispy texture for a while (for example, while eating). Furthermore, since non-fat powdered milk, which is a product obtained by removing fat from milk, is added to yogurt, the original flavor of yogurt will not likely to be impaired. On the other hand, since dextrin is added to yogurt together with non-fat powdered milk, the amount of non-fat powdered milk, which is relatively expensive, can be reduced. Thus, the dry solid yogurt of the embodiment can be attained at a low cost.

As described above, the dry solid yogurt according to the embodiments of the present invention can be suitably adopted for use in a mixture with other dry food. Therefore, the healthiness of yogurt as solid, different from powder, can be visually appealing. The dry solid yogurt according to the embodiments of the present invention can be applied to a wide range of use in combination with various dry food and materials, such as dried food sprinkled over rice, snack, etc. as well as cereal food.

Dextrin that can be used in the embodiments is not limited to a specific kind. However, in one embodiment, it is preferable to select dextrin based on a dextrose equivalent (DE). This is because at least one of the shape retention (strength), water resistance, and texture of the dry solid yogurt can be improved by using dextrin with a suitable DE. In one embodiment, preferably, dextrin having DE of 5 to 12 is used, and more preferably, dextrin having DE of 6 to 10 is used.

In one embodiment of the present invention, the compounding ratio of the yogurt, non-fat powdered milk, and dextrin, which are used as a material, preferably satisfies the conditions of the following formula (I):

20%≤a+b≤40% and 0%<b<20% (I)

In formula (I), “a” denotes a mass percentage (%) of non-fat powdered milk relative to yogurt, and “b” denotes a mass percentage (%) of dextrin relative to yogurt.

Thus, from the viewpoint of shape retention, water resistance, texture, and flavor, it is preferable that the sum of non-fat powdered milk and dextrin added to the material yogurt be 20 to 40% of the mass of yogurt, and dextrin is less than 20% of the mass of yogurt.

In the above formula (I), the condition of a+b may be 25%≤a+b≤35%. The condition of b may be 5%<b<15%.

In the embodiments, the compounding ratio between non-fat powdered milk and dextrin is not particularly restrictive. The compounding ratio between non-fat powdered milk and dextrin can be set appropriately, for example, in a range that satisfies the above formula (I).

The dry solid yogurt of the embodiments can contain any component other than yogurt, non-fat powdered milk, and dextrin described above, as long as the advantageous effects of the invention are not impaired. However, in one embodiment, it is preferable that allergens such as gelatin not be contained in the dry solid yogurt.

As described above, the dry solid yogurt of the embodiments is obtained by vacuum freeze-drying yogurt containing non-fat powdered milk and dextrin. In one embodiment, a method for producing a dry solid yogurt includes:

mixing yogurt, non-fat powdered milk, and dextrin;

freezing a mixture obtained by the mixing; and

vacuum freeze-drying a frozen product obtained by the freezing.

The mixture obtained by the mixing has a water content ratio of, preferably 60 to 70 mass %, and more preferably 62 to 68 mass %.

Conditions in the mixing, freezing and vacuum freeze-drying may be set appropriately in accordance with the conventional technique. The mixture of yogurt, non-fat powdered milk, and dextrin obtained by the mixing may be frozen after being first filled in a container of any shape prepared in advance, and then vacuum freeze-dried. Alternatively, the mixture may be frozen to form a plate shape and then vacuum freeze-dried, or the frozen plate may be cut into predetermined shapes and the cuts may be vacuum freeze-dried. The vacuum freeze-dry may be performed under the conditions of, for example, a degree of vacuum 40-50 Pa, and a shelf temperature of about 60° C.

### EXAMPLES

Hereinafter, the present invention will be described specifically based on examples, but the present invention is not limited by the examples.

### Example 1

Performances of dry solid yogurt obtained by adding only one of soluble starch (DE=0), dextrin (DE=7.5, 11, or 25), and non-fat powdered milk alone to yogurt were evaluated.

[Preparation of Dry Solid Yogurt 1a]

To yogurt (“Megumi” (registered trademark) produced by Megumilk Snow Brand Company, Limited), soluble starch (produced by Matsutani Chemical Industry Co., Ltd., DE=0) at 10 mass % of the total mass of the yogurt was added and stirred. The obtained mixture was frozen to form a plate in a freezer at −40° C. The frozen plate was cut into cubes of about 1 cm×1 cm, which were vacuum freeze-dried (a degree of vacuum 50 Pa, and a shelf temperature 60° C.), thereby obtaining dry solid yogurt 1a.

[Preparation of Dry Solid Yogurt 1b]

Dry solid yogurt 1b was obtained in the same manner as in the method for preparing the dry solid yogurt 1a except that dextrin of DE=7.5 (produced by Matsutani Chemical Industry Co., Ltd.) was used instead of the aforementioned soluble starch (DE=0) used in the preparation of dry solid yogurt 1a.

[Preparation of Dry Solid Yogurt 1c]

Dry solid yogurt 1c was obtained in the same manner as in the method for preparing the dry solid yogurt 1a except that dextrin of DE=11 (produced by Matsutani Chemical Industry Co., Ltd.) was used instead of the aforementioned soluble starch (DE=0) used in the preparation of dry solid yogurt 1a.

[Preparation of Dry Solid Yogurt 1d]

Dry solid yogurt 1d was obtained in the same manner as in the method for preparing the dry solid yogurt 1a except that dextrin of DE=25 (produced by Matsutani Chemical Industry Co., Ltd.) was used instead of the aforementioned soluble starch (DE=0) used in the preparation of dry solid yogurt 1a.

[Preparation of Dry Solid Yogurt 1e]

Dry solid yogurt 1e was obtained in the same manner as in the method for preparing the dry solid yogurt 1a except that non-fat powdered milk (produced by Yotsuba Milk Products Co., Ltd.) was used instead of the aforementioned soluble starch (DE=0) used in the preparation of dry solid yogurt 1a.

[Preparation of Dry Solid Yogurt 1f]

Dry solid yogurt if was obtained in the same manner as in the method for preparing the dry solid yogurt 1e except that the amount of non-fat powdered milk was increased from 10 mass % to 20 mass % of the total mass of the yogurt.

[Evaluations]

About 1.5 g (about 4 to 6 pieces) of the dry yogurt cubes 1a to 1f of about 1 cm×1 cm were respectively put into glass beakers of 300 ml, together with commercially available cornflakes of 5 g. Each of the glass beakers has a baffle plate having a width of about 1 cm, which is provided on an inner wall of the glass beaker, extending from the opening toward the bottom, and projecting radially inward. The beaker containing the mixture of the dry yogurt and the cornflakes (hereinafter referred to as “the sample”) was set in a shaking incubator for performing circular motions at 330 rpm at a stroke of 23 mm, and the shaking incubator was operated for one minute.

Shape Retention (Degree of Abrasion Resistance)

In the samples after the operation described above, a mass of the dry solid yogurt that remained in the shape of blocks, such as cubes, was measured. The value obtained by dividing the mass of the remaining by the mass of the sample before the operation is a degree of abrasion resistance, which is evaluated as the shape retention. In the description, “the dry solid yogurt that remained in the shape of blocks” means the dry solid yogurt that remained after removing the cornflakes from the sample, and then sieving with a sieve opening of 2 mm. The results are shown in Table 1. An abrasion resistance of about 85% or higher indicates that the dry solid yogurt has a strength sufficient to withstand friction with cereals or a shock in transportation.

Water Resistance

Milk at 10° C. was poured into the samples after the above operation was ended. The degree of dissolution in appearance of the dry solid yogurt, the degree of floating on the milk surface or the degree of settling in the milk, or the degree of absorption of milk into the solid within 10 minutes of pouring were comprehensively evaluated in terms of cereal products by an experienced panelist who is responsible in product development of dry solid yogurt. The results are shown in Table 1.

Texture

Milk at 10° C. was poured into the samples after the above operation was ended. After the samples were left standing for 10 minutes following pouring, the aforementioned panelist ate the samples and evaluated the texture. The results are shown in Table 1.

TABLE 1

| | | | Evaluation | | |
|---|---|---|---|---|---|
| | | | Shape retention | | |
| Dry | | Compounding | (degree of | | |
| solid | | ratio | abrasion | | |
| yogurt | Additive | (mass %) | resistance %) | Water resistance | Texture |
| 1a | Soluble | 10 | 95.3 (good) | Undissolved and | Dried gel |
| | starch | | | mostly floating on | starch-like |
| | DE = 0 | | | aqueous surface. | texture. Low |
| | | | | | crispiness. |
| 1b | Dextrin | 10 | 65.1 (a little | Immediately starts | Cannot be |
| | DE = 7.5 | | fragile) | dissolving. Most | eaten together |
| | | | | dissolvable of three | with cereal |
| | | | | types of dextrin | because of |
| | | | | (DE = 7.5, 11, 25). | dissolving |
| | | | | Suspending under | property. High |
| | | | | aqueous surface, | void ratio; |
| | | | | but dissolved by | crispy in dry |
| | | | | stirring | state. |
| 1c | Dextrin | 10 | 65.8 (a little | Gradually dissolved | Crispiness in |
| | DE = 11 | | fragile) | and settled, but | dry state lost. |
| | | | | partly floating on | Semi-solid |
| | | | | aqueous surface. | yogurt-like |
| | | | | Milk absorbed into | texture. |
| | | | | middle part of | |
| | | | | solids. | |
| 1d | Dextrin | 10 | 54.9 (fragile) | Same as 1c. Solids | A little sticky; |
| | DE = 25 | | | floating on aqueous | crispiness in |
| | | | | surface larger than | dry state lost. |
| | | | | 1c. | Sticky paste- |
| | | | | | like texture. |
| 1e | Non-fat | 10 | 24 (very | Immediately starts | Crispiness in |
| | powdered | | fragile) | dissolving and | dry state lost. |
| | milk | | | settled, but partly | Semi-solid |
| | | | | on aqueous surface. | yogurt-like |
| | | | | Milk absorbed into | texture. |
| | | | | middle part of | |
| | | | | solids. | |
| 1f | Non-fat | 20 | 79.3 (a little | Undissolved but | Crispiness in |
| | powdered | | fragile) | milk absorbed into | dry state lost. |
| | milk | | | middle part of | Shape |
| | | | | solids. | retention lost |
| | | | | | in mouth. Low |
| | | | | | crispiness. |

From the results shown in Table 1, first, in the case of adding either dextrin or non-fat powdered milk was added, it is evident that dry solid yogurt which is excellent in all of the shape retention, the water resistance, and the texture was not obtained.

When comparing the dry solid yogurts 1a to 1e, containing an additive at a compounding ratio of 10 mass % relative to yogurt, it is evident that dextrin is more effective in improving the shape retention (degree of abrasion resistance) than non-fat powdered milk.

When comparing the dry solid yogurts 1a to 1d, it is evident that the DE value influences the shape retention, the water resistance, and the texture. The lower the DE value of dextrin, the poorer the water resistance. However, the soluble starch of the DE value 0 is excellent in water resistance, but poor in crispy texture. On the other hand, in comparison with the soluble starch of the DE value 0, the crispy texture is improved as the DE value increases. However, in the case of the DE value 25, the texture resembles sticky paste and lacks crispiness.

Based on the above results, further studies were carried out. As will be explained later in connection with Example 2, it was confirmed that the comprehensive evaluation of the shape retention, the water resistance, the texture and the flavor was improved by using both dextrin and non-fat powdered milk as additives to yogurt, in comparison with the case of using only one additive.

Influences of the DE value of dextrin on the shape retention, the water resistance, the texture, and the flavor were further studied. As a result, it was confirmed that the DE value 5 to 12 of dextrin is preferable, and the DE value 6 to 10 is more preferable.

### Example 2

The influences of the use of the combination of dextrin and non-fat powdered milk as additives to yogurt on the performance of the dry solid yogurt were evaluated as described above. Further, influences of the compounding ratio between dextrin and non-fat powdered milk on performance of the dry solid yogurt were evaluated.

[Preparation of Dry Solid Yogurt]

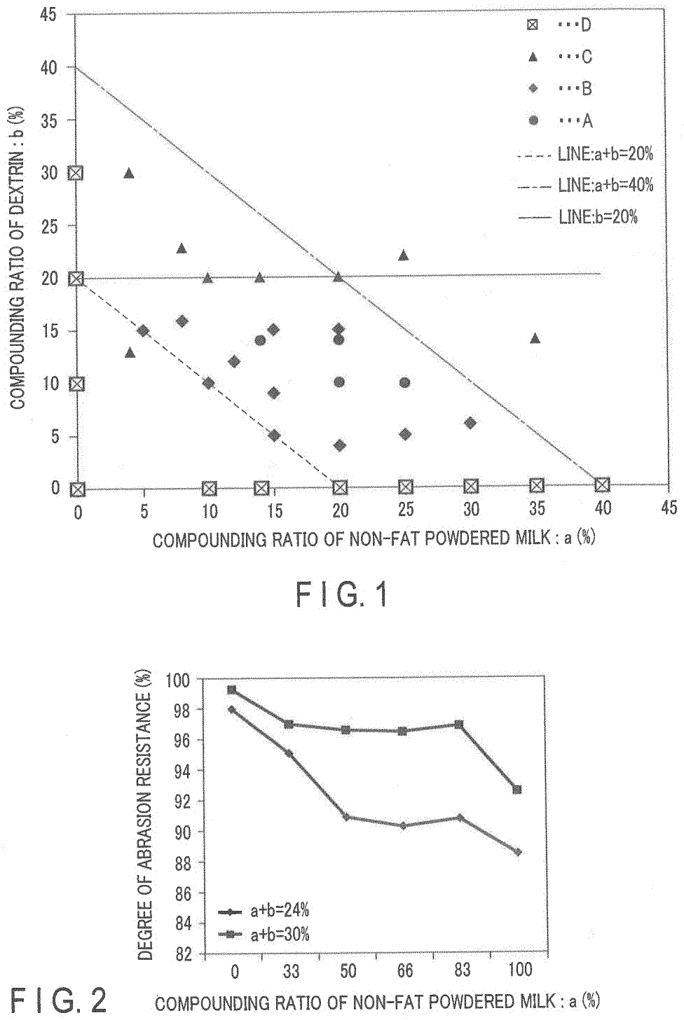

Yogurt (“Megumi” (registered trademark) produced by Megumilk Snow Brand Company, Limited), dextrin (produced by Matsutani Chemical Industry Co., Ltd., DE=7.5), and non-fat powdered milk (produced by Yotsuba Milk Products Co., Ltd.) were used as materials. In the same manner as in the method of preparation of the dry solid yogurt of Example 1 described above, dry yogurt cubes of about 1 cm×1 cm, having different compounding ratios of dextrin and non-fat powdered milk relative to yogurt, were prepared. The compounding ratio of dextrin and non-fat powdered milk relative to yogurt was determined such that the sum of dextrin and non-fat powdered milk was varied from 0 mass % to 50 mass % relative to yogurt, and further, the compounding ratio between dextrin and non-fat powdered milk was varied (refer to FIG. 1).

[Evaluations]

The shape retention (degree of abrasion resistance), the water resistance, the texture, and the flavor were evaluated in the same manner as in Example 1. Further, it was evaluated whether or not the “flavor” including taste, scent, sourness inherent in yogurt was lost. The aforementioned panelist evaluated “flavor” based on whether or not favorable characteristics in terms of taste inherent in yogurt were maintained. Based on the evaluation results, the panelist classified the dry yogurt cubes into categories A to D, described below, as a comprehensive evaluation of performances. FIG. 1 is a scatter plot graph of the comprehensive evaluation.

Comprehensive Evaluation

D: Two or more of the performances of the shape retention (degree of abrasion resistance), the water resistance, the texture and the flavor are very poor, and are therefore not suitable for use in combination with cereal food.

C: One or more of the performances are better as compared to D.

B: All of the performances of the shape retention (degree of abrasion resistance), the water resistance, the texture and the flavor are excellent.

A: All of the performances of the shape retention (degree of abrasion resistance), the water resistance, the texture and the flavor are excellent. In particular, the texture and the flavor are suitable for cereal food.

As evident from the scatter plot graph of FIG. 1, the comprehensive evaluation is improved by using both dextrin and non-fat powdered milk as additives to yogurt, in comparison with the case of using either one additive. Furthermore, it is evident that the comprehensive evaluation of the dry solid yogurt is further improved if the sum (a+b) of the mass percentages a (%) of non-fat powdered milk relative to yogurt and the mass percentage b (%) of dextrin falls within the range of 20% to 40%, and the mass percentage b (%) of dextrin is less than 20%, namely, if the conditions of the following formula (I) are satisfied:

20%≤a+b≤40% and 0%<b<20% (I)

### Example 3

Influences of the compounding ratio between non-fat powdered milk and dextrin on the shape retention (degree of abrasion resistance) were evaluated.

[Preparation of Dry Solid Yogurt]

Yogurt (“Megumi” (registered trademark) produced by Megumilk Snow Brand Company, Limited), dextrin (produced by Matsutani Chemical Industry Co., Ltd., DE=7.5), and non-fat powdered milk (produced by Yotsuba Milk Products Co., Ltd.) were used as materials. In the same manner as in the method of preparation of the dry solid yogurt of Example 1 described above, dry yogurt cubes of about 1 cm×1 cm, having different compounding ratios between dextrin and non-fat powdered milk were prepared. The compounding ratio between dextrin and non-fat powdered milk was determined such that the sums of mass percentages of dextrin and non-fat powdered milk are 24% and 30% relative to yogurt, and the compounding ratio of non-fat powdered milk was varied from 0 to 100 mass %. The values 24% and 30% of the compounding ratio were selected as satisfying the condition 20%≤a+b≤40% in the formula (I).

[Evaluations]

The shape retention (degree of abrasion resistance) was evaluated in the same manner as in Example 1 described above. The results are shown in FIG. 2. As evident from the graph of FIG. 2, in the case of the dry solid yogurt of the sums in which mass percentages of dextrin and non-fat powdered milk relative to yogurt are 24% and 30%, which fall within the range from 20 mass % to 40 mass %, regardless of whichever the compounding ratio between non-fat powdered milk and dextrin is, the shape retention exceeds 85%; that is, a standard of excellent shape retention and strength sufficient to withstand processing of mixing with cereals or transportation. Furthermore, it is evident that the shape retention (degree of abrasion resistance) increases as the compounding ratio of dextrin increases, in comparison with the case of adding only non-fat powdered milk (in the case where the compounding ratio of non-fat powdered milk is 100%).

### Example 4

Non-fat powdered milk 20 g (produced by Yotsuba Milk Products Co., Ltd.) and dextrin 10 g (produced by Matsutani Chemical Industry Co., Ltd., DE=7.5) in the form of powder were mixed with plain yogurt (“Megumi” (registered trademark) produced by Megumilk Snow Brand Company, Limited), and the mixture was shaped into a plate and frozen in a freezer at −40° C. The frozen plate was cut into cubes of about 1 cm×1 cm, which were vacuum freeze-dried. As a result, cubes of intended dry solid yogurt were obtained.

With regard to the dry solid yogurt obtained, the shape retention (degree of abrasion resistance), the water resistance, and the texture were evaluated in the same manner as in Example 1. As a result, the degree of abrasion resistance was 92.3%. The result is much higher than 85%, which constitutes a standard of excellent shape retention. Thus, it is evident that the dry solid yogurt of this example was excellent in shape retention. Furthermore, after adding milk at 10° C. and leaving the mixture standing for 10 minutes, the dry solid yogurt was still floating on the surface of the milk and maintained its crispiness. Thus, the dry solid yogurt from this example was also excellent in water resistance and crispy texture.

The present invention is not limited to the above-described embodiments, and can be modified in various manners when reduced to practice, without departing from the gist of the invention. The embodiments can be combined as appropriate if possible. In that case, combinational effects can be obtained. In addition, the above-described embodiments include inventions of various stages, and a variety of inventions can be derived by properly combining elements selected from the elements disclosed in connection with the embodiments. For example, if omission of several features from the whole configuration or structure disclosed for the embodiments would solve the problems and provide the effects, the configuration or structure after such omission of the elements may be derived as an invention.

1. A dry solid yogurt comprising a vacuum freeze-dried product containing yogurt, non-fat powdered milk, and dextrin.

2. The dry solid yogurt according to claim 1, wherein a compounding ratio of the yogurt, the non-fat powdered milk, and the dextrin, as a material to be subjected to vacuum freeze-dry, satisfies formula (I):
20%≤a+b≤40% and 0%<b<20% (I)
where a denotes a mass percentage (%) of non-fat powdered milk relative to yogurt, and b denotes a mass percentage (%) of dextrin relative to yogurt.

3. The dry solid yogurt according to claim 1, wherein a dextrose equivalent (DE) of the dextrin is 5 to 12.

4. The dry solid yogurt according to claim 1, wherein the yogurt is raw milk yogurt.

5. The dry solid yogurt according to claim 1, wherein no gelatin is contained.

6. Cereal food containing the dry solid yogurt according to claim 1.

7. A method for producing a dry solid yogurt comprising:
mixing yogurt, non-fat powdered milk, and dextrin;
freezing a mixture obtained by the mixing; and
vacuum freeze-drying a frozen product obtained by the freezing.

8. The method for producing a dry solid yogurt according to claim 7, wherein a compounding ratio of the yogurt, the non-fat powdered milk, and the dextrin, to be used in the mixing satisfies formula (I):
20%≤a+b≤40% and 0%<b<20% (I)
where a denotes a mass percentage (%) of non-fat powdered milk relative to yogurt, and b denotes a mass percentage (%) of dextrin relative to yogurt.

9. The method for producing a dry solid yogurt according to claim 7, wherein the mixture obtained by the mixing has a water content ratio of 60 to 70 mass %.

10. The method for producing a dry solid yogurt according to claim 7, wherein a dextrose equivalent (DE) of the dextrin is 5 to 12.

11. The dry solid yogurt according to claim 7, wherein the yogurt is raw milk yogurt.

12. The dry solid yogurt according to claim 7, wherein the dry solid yogurt contains no gelatin.
